(19) United States
(12) Patent Application Publication
(10) Pub. No.: US 2007/0071233 A1
(43) Pub. Date: Mar. 29, 2007

(54) Hash function using arbitrary numbers

(75) Inventor: Emil Zak, Modiin (IL)

Correspondence Address: WOLF, BLOCK, SCHORR & SOLIS-COHEN LLP, 250 PARK AVENUE, NEW YORK, NY, 10177, US

(73) Assignee: Allot Communications Ltd., Hod-Hasharon (IL)

(21) Appl. No.: 11/237,840

(22) Filed: Sep. 27, 2005

(51) Int. Cl. H04L 9/28; H04L 9/00; H04K 1/00

(52) U.S. Cl. 380/28; 713/181; 380/46

(57) ABSTRACT

A hash unit, including an input interface adapted to receive an input key, an arbitrary number generator adapted to generate one or more arbitrary numbers, a processor adapted to apply a multi-operand function to an input key received by the input interface together with each of one or more arbitrary numbers generated by the generator so as to generate intermediate results, to mathematically combine the digits of the intermediate results to generate respective short bit results having less than half the bits of the intermediate results and to concatenate the short bit results and an output unit adapted to provide the concatenated short bit results for use as an output hash key.

### FIELD OF THE INVENTION

The present invention relates to communication systems and in particular to hash functions used in communication systems.

### BACKGROUND OF THE INVENTION

The large amounts of data transmitted through communication networks cannot always be handled by a single handling unit (e.g., processor, server, router, proxy). Therefore, in some cases, a plurality of handling units are employed in parallel to handle the communication traffic. Generally, packets belonging to a same connection need to be handled by the same handling unit, and therefore random direction of the packets to the handling units, for example cyclically, is not desired. It is, however, highly desired that the traffic be distributed evenly between the handling units operating in parallel, so as to maximize the utilization of the handling units and minimize delay caused by the handling units.

One possibility for directing the packets to the handling units is to use a single load balancer which receives all the packets and forwards each packet to one of the handling units. The single load balancer manages a history table in which each connection is listed with the handling unit that handles the packets of the connection. This, however, requires that a single load balancer receives all the packets passing through the handling units. In addition, the single load balancer may need to manage a large history table.

Another possibility is to use a hash function to direct each packet to a specific handling unit. Hash functions are functions that convert input values (referred to as input keys) belonging to a large range of values into output values (referred to as output keys) that belong to a small range of values. In load balancing, the input keys are formed of fields of the packet headers and the output key is from a range including only a single value for each handling unit. Thus, each packet is directed to a specific handling unit, without requiring management of history tables. The use of the hash function allows selecting a handling unit for a packet by a plurality of separate load balancing units, without requiring that the load balancing units communicate with each other.

Hash functions for load balancing are described, for example, in U.S. Pat. No. 6,853,638 to Cohen, PCT publication WO 2004/002019 and U.S. Pat. No. 6,778,495 to Blair, the disclosures of all of which documents are incorporated herein by reference.

The use of a hash function, however, does not necessarily result in even distribution of the packet load, as is the case with load balancing based on history tables. What is required is a hash function that has a distribution as close as possible to an even distribution.

Many hash functions are chosen based on the statistical distribution of the values of the input key, in order to achieve an even distribution. Bits of the input key that hardly change, for example, are not used in generating the output key. Statistically chosen hash functions require adaptation to their specific use, are not portable and give an uneven distribution when the statistics of the values of the input key change.

U.S. Pat. No. 6,667,980 to Modi et al., U.S. patent publication 2003/0221107 to Kang, and U.S. patent publication 2004/0220975 to Carpentier et al., the disclosures of which documents are incorporated herein by reference, describe various hash functions, different from the hash function proposed in the present patent application.

### SUMMARY OF THE INVENTION

An aspect of some embodiments of the present invention relates to a hash function that uses a multi-operand function (e.g., ‘and’,‘or’) on an input value and an arbitrary number and then mathematically combines (e.g., sums) the digits of the result to receive a hash result of one or more bits. In some embodiments of the invention, the hash function involves applying a multi-operand function to the input value and a plurality of different arbitrary numbers to generate a plurality of respective hash results, optionally one digit binary results. A final hash result is optionally generated by concatenating the hash results corresponding to all the arbitrary numbers. The number of arbitrary numbers used depends on the required size of the output key of the hash function.

The arbitrary numbers are optionally selected without relation to the expected input values of the hash function and/or the statistical distribution of the input values. In some embodiments of the invention, the arbitrary numbers are selected using a random number generator or a semi-random number generator. Possibly, the arbitrary numbers are derived randomly but are filtered or otherwise processed, to make sure the numbers meet minimal conditions for the hash function.

The use of arbitrary numbers in the above method was found in simulations to achieve an even distribution of the final hash results. The use of arbitrary numbers arbitrarily selects the bits of the input value to affect the hash result. The summing of the bits of the result of the multi-operand function gives even weight to all the bits of the result, and hence even if the input values are concentrated around specific values, the final hash result has an even distribution. Thus, the hash function achieves a relatively even distribution of output values from input keys of substantially any statistical distribution, without relation to the specific distribution of the values of the input key and/or without relation to the size of the output key. Furthermore, beyond selection of arbitrary values of a suitable size, the hash function of some embodiments of the present invention does not depend on the size of the input key.

In some embodiments of the invention, the hash function is used for load balancing. Optionally, the same arbitrary numbers are used by all load balancers of an array of handling units, so that the same result is achieved by all the load balancers of the array. The arbitrary numbers are optionally used on all packets received during the time for which they are applicable (e.g., a day, a week, a month).

The hash function receives as the input key, portions of the headers of packets which are to be load balanced. Each packet is assigned by the hash function an output key which corresponds to one of the handling units. The hash function always assigns the same output key to the same input key, as long as the arbitrary numbers are not replaced. The header portions provided to the hash function have the same values in packets belonging to the same channel, and hence all packets of the same channel are directed to the same handling unit.

In some embodiments of the invention, the hash function is applied by a processor which is occasionally restarted. Optionally, when the processor is restarted, the arbitrary numbers to be used for the next day, week or until the processor is again restarted, are selected randomly by the processor, to make it difficult to learn the arbitrary numbers, for example in order to predict the operation of the server. In some embodiments of the invention, the arbitrary numbers are replaced sufficiently often such that the arbitrary numbers are generally replaced before it is possible to determine the arbitrary numbers. Optionally, on the average, the arbitrary numbers are replaced at least once a week or even at least once every three days.

In some embodiments of the invention, the application of the multi-operand function on each arbitrary number results in a single bit hash result, such that the number of bits in the final hash result is equal to the number of arbitrary numbers used. It is noted that the final hash result may then be further processed, for example to convert it into a number belonging to a different range (e.g., by multiplying by a fraction).

There is therefore provided in accordance with an exemplary embodiment of the invention, a method of providing a hash addressing number based on an input value, comprising receiving an input value, providing one or more arbitrary numbers, for each of the one or more arbitrary numbers, applying a multi-operand function to the input value and the arbitrary number, to generate an intermediate result, mathematically combining the digits of the intermediate results to generate respective short bit results having less than half the bits of the intermediate results and using the short bit results as an output hash number or to form an output hash number for the input value.

Optionally, receiving the input value comprises receiving at least one field of an IP packet. Optionally, receiving at least one field of an IP packet comprises receiving an input value including only one or more entire logical fields of an IP packet. Optionally, receiving the input value comprises receiving a string formed of one or more fields selected as a sub-group from a larger group of fields determined to be suitable for use in the hash, the selection of the sub-group being performed without relation to the statistical distribution of the values of the bits of the larger group. Optionally, providing the one or more arbitrary numbers comprises providing one or more numbers generated by a random number generator.

Optionally, providing the one or more arbitrary numbers comprises providing numbers which are generated each time a system using the hash number is restarted.

Optionally, the multi-operand function comprises a two-operand function, such as a logical bitwise function. Optionally, the multi-operand function is the same for all the one or more arbitrary numbers. Optionally, the one or more arbitrary numbers include a plurality of numbers and wherein different multi-operand functions are used for at least two of the arbitrary numbers. Optionally, the multi-operand function is one of ‘or’, ‘and’, ‘nor’ and ‘nand’. Optionally, mathematically combining the digits of the intermediate results comprises summing the digits into a single bit.

Optionally, using the short bit results to form an output hash number for the input value comprises concatenating the short bit results to form a single number. Optionally, using the short bit results comprises using the short bit results or the output hash number for load balancing. Optionally, using the short bit results comprises using the short bit results or the output hash number for memory access.

There is further provided in accordance with an exemplary embodiment of the invention, a hash unit, comprising an input interface adapted to receive an input key, an arbitrary number generator adapted to generate one or more arbitrary numbers, a processor adapted to apply a multi-operand function to an input key received by the input interface together with each of one or more arbitrary numbers generated by the generator so as to generate intermediate results, to mathematically combine the digits of the intermediate results to generate respective short bit results having less than half the bits of the intermediate results and to concatenate the short bit results and an output unit adapted to provide the concatenated short bit results for use as an output hash key.

Optionally, the arbitrary number generator is adapted to generate new arbitrary numbers, each time the hash unit is restarted.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic block diagram of a network device, in accordance with an exemplary embodiment of the invention;

FIG. 2 is a schematic block diagram of a network device, in accordance with another exemplary embodiment of the invention;

FIG. 3 is a flowchart of acts performed by a hash unit, in accordance with an exemplary embodiment of the invention;

FIG. 4 is a schematic illustration of data access to a memory unit, in accordance with an exemplary embodiment of the invention; and

FIG. 5 is a schematic block diagram of a hash unit, in accordance with an exemplary embodiment of the invention.

### DETAILED DESCRIPTION OF EMBODIMENTS

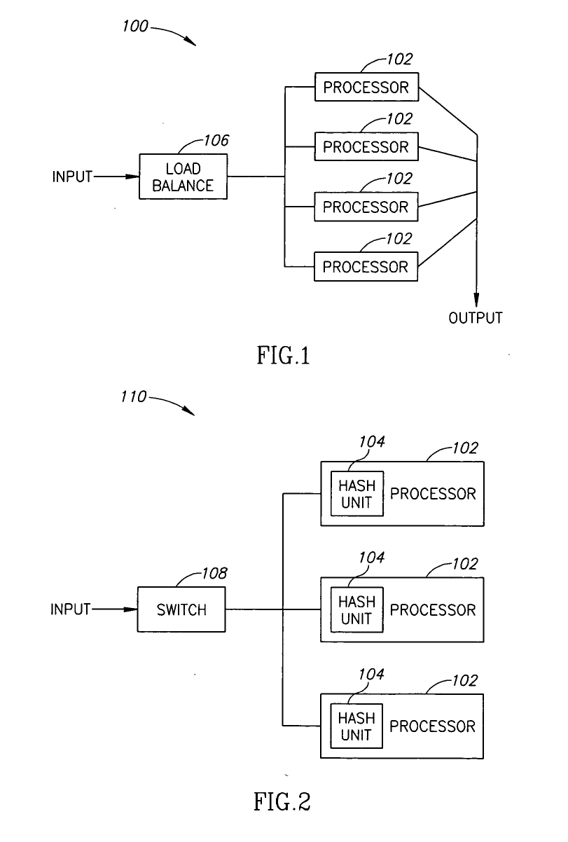

FIG. I is a schematic block diagram of a network device 100, in accordance with an exemplary embodiment of the invention. Network device 100 includes a plurality of processors 102 and a load balancer 106. All the packets directed to network device 100 are optionally forwarded to load balancer 106. Load balancer 106 distributes the packets to processors 102 for handling, using a hash function applied to the headers of the packets, as described hereinbelow in detail. While load balancer 106 is shown as a separate unit from processors 102, it may be mounted (e.g., as a software process or a hardware plug-in) on one of processors 102. Processors 102 may forward the packets, after handling, back through load balancer 106 or may forward the packets directly to their destination without passing through load balancer 106, as illustrated in FIG. 1.

FIG. 2 is a schematic block diagram of a network device 110, in accordance with another exemplary embodiment of the invention. Alternatively to using a load balancer 106 (FIG. 1) which examines the packet headers and determines which processor 102 handles each packet, each processor 102 in network device 110 includes a hash unit 104, which performs the task of the load balancer 106. The hash unit 104 determines, using the hash function described below, whether packets should be handled by the processor 102 in which it is hosted or should be forwarded to a different processor 102. A switch 108 optionally distributes the packets directed to network device 110 between processors 102 substantially evenly, without relation to the header contents. Processors 102 may forward the packets, after handling, back through switch 108 as shown in FIG. 2, or may forward the packets directly to their destination without passing through switch 108.

Alternatively to rerouting the packet to its designated processor 102, each packet is directed to all of hash units 104. Hash units 104 optionally discard packets that they are not to handle, as determined by the hash function.

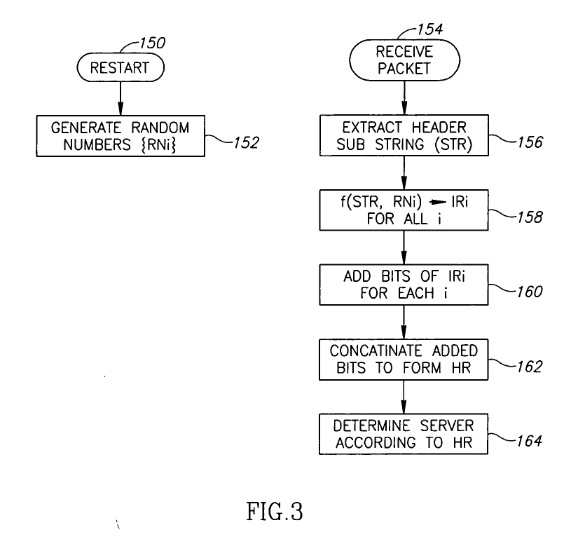

FIG. 3 is a flowchart of acts performed by each of hash units 104 (or by load balancer 106), in accordance with an exemplary embodiment of the invention When network device 100 is restarted (150), hash units 104 generate (152) together a set of i random numbers {RNᵢ} for use in the current operation session of hash units 104. The number i of random numbers in the set depends on the number of processors 102 in network device 100, or more generally stated on the required size of the output key, as discussed in detail below.

Upon receiving (154) a packet for processing, hash unit 104 extracts (156) from the header of the packet a sub-string STR to serve as the input key of the hash. A two operand logical function f(x,y) is applied (158) to the sub-string STR with each of the random numbers of the current random number set {RNᵢ} as the second operand, so as to generate intermediate results {IRᵢ}, IRᵢ=f(STR,RNᵢ). The bits of each of the intermediate results IRᵢ are added together (160) so as to generate for each intermediate result IRᵢ a single bit Bᵢ, which represents the original sub-string STR of the packet for the corresponding random number RNᵢ. The resulting bits Bᵢ are optionally concatenated (162) to form a hash result HR for the received packet. Hash unit 104 determines (164) which of processors 102 is to handle the packet, responsive to the hash result HR. In an exemplary embodiment of the invention, network device 100 includes 2ˆi processors 102, each processor being assigned a unique i-bit value as its identity. The packet is optionally handled by the processor 102 with the identity value equal to the hash result HR.

Referring in more detail to generating (152) the set of random numbers {RNᵢ}, in some embodiments of the invention the number i of random numbers in the set is the lowest integer that is greater than log₂(number of processors 102). Using this number of random numbers RNᵢ provides the resulting hash result HR with a sufficient number of possible values so that each processor 102 has a corresponding possible value of HR, using minimal processing resources. In some embodiments of the invention, network device 100 includes a number of processors that is a power of 2, such that the number of random numbers i equals the base 2log of the number of processors 102, i.e., i=log₂(num(processors)). Stated differently, in these embodiments, each value of the hash result HR has a corresponding processor 102. Alternatively to each value of the hash result HR having a corresponding processor 102, in determining (164) a processor 102, the hash result HR is scaled to the number of processors, for example by multiplying HR by (num(processors))/(2ˆi). In some embodiments of the invention, the scaling is performed using a modulo operation. Further alternatively or additionally, a separate arbitration function (e.g., accessing a table) is used when HR receives a value not corresponding to a processor 102.

In some embodiments of the invention in which the number of processors 102 is not a power of 2, a larger number i, for which 2ˆi divided by the number of processors is close to an integer, is used. A processor 102 is selected based on HR by multiplying HR by (num(processors))/(2ˆi) and truncating. For example, for 7 processors, i=6 may be used and HR is divided by 9 and truncated in order to generate a result.

Optionally, the random numbers {RNᵢ} are of the same length as the sub-strings STR, allowing a highly meaningful logical function operation between the random numbers and the packet sub-strings STR. Alternatively, the random numbers may be slightly shorter or slightly longer (e.g., by 2-3 bits) than the packet sub-strings STR. If necessary, a predetermined padding scheme is used for bits of one of the operands not having a corresponding bit in the other operand.

The random numbers {RNᵢ} are optionally generated using any random number generation method or any quazi-random generation method known in the art. In some embodiments of the invention, the resultant random numbers {RNᵢ} are checked to determine whether they meet required minimal constraints, such as that they have a number of ‘1’bits between minimal and maximal threshold values and/or that the random numbers do not include a consecutive run of the same digit longer than a predetermined threshold (e.g., 30 bits). In an exemplary embodiment of the invention, random numbers in which more than 70% (or 80%) of the bits are of the same value are discarded and a different random number is generated in their place. Alternatively, hash units 104 are configured with a list of tested random numbers. When a new random number (or set of random numbers) is required, numbers are selected from the list, for example randomly or in a cyclic order.

Alternatively to using random numbers, any other arbitrary numbers which are selected without relation to the statistical distribution of the input values of the sub-string STR are used. In some embodiments of the invention, when several arbitrary numbers are used, the arbitrary numbers are selected as having a desired overlap of values. For example, each two arbitrary numbers may be required to have a predetermined number of ‘1’ values in same positions. Alternatively or additionally, each pair of arbitrary numbers is required to have a ‘1’ value in at least one of the number 90% of the positions. In some embodiments of the invention, each position of the arbitrary numbers is required to have a ‘1 ’ value in a predetermined number of the arbitrary numbers or within a number of arbitrary numbers between a minimum and maximum value.

In some embodiments of the invention, one of hash units 104 or processors 102 generates the random numbers at start up and transfers the generated numbers to the other hash units 104 for usage. Alternatively, when arbitrary numbers from a predetermined list are used, the same rules are used by all of hash units 104 in selecting, separately, the arbitrary numbers, such that the same arbitrary numbers are used by all of hash units 104.

Referring in detail to extracting (156) from the packet a sub-string STR, in some embodiments of the invention the sub-string STR includes the source and destination addresses in the packet header, the protocol field in the packet header, and the source and destination ports of the packet header. Alternatively, the sub-string STR is formed of a sub-group of the five above listed fields, such as only the source and destination addresses.

The logical fields of the packet header that are included in the sub-string STR are optionally only those fields whose values affect whether the two packets should be handled by a single processor 102, e.g., the source and destination addresses. That is, logical fields of the packet that have no bearing on whether the packets should be handled together are optionally not included in sub-string STR, as unexpected or expected changes in their values may cause two different packets that should be handled by the same processor 102, to be sent to different processors 102.

Optionally, the selection of the logical fields included in sub-string STR, from those fields which may be used according to the above discussion, is performed without relation to the statistical distribution of the values of the field. Furthermore, the selection of the logical fields included in the sub-string STR, from those fields which may be used according to the above discussion, is optionally performed without examination of the type of data in the fields and/or without examination of the statistical distribution of their values. For example, in selecting fields to be included in sub-string STR there is no need to exclude fields which have constant values or generally have values not evenly distributed, since the addition of the intermediate results IRᵢ into a limited number of bits substantially eliminates any adverse affect of such fields on the final result.

In some embodiments of the invention, sub-string STR is formed of one or more entire logical fields of the packet headers, and no logical fields are included only partially in the sub-string STR. This simplifies the construction of the sub-string STR, as there is no need to determine which parts of the logical fields are better suited for a hash function. In other embodiments of the invention, only portions of one or more fields are used, for example in order to reduce the size of the sub-string STR. Such portions are optionally selected randomly, from those fields that can be included in sub-string STR, without examination of the value distributions of the fields.

Alternatively to all the random numbers {RNᵢ} having the same length, some of the random numbers may have shorter lengths than others. These shorter random numbers are optionally used as operands with respective sub-sub-strings of the headers of the packets. For example, one of the random numbers may be applied to five fields of the headers of the packets, while one or more other random numbers are applied only to three fields of the headers of the packets. Use of this alternative, reduces the processing resources required to apply the hash operation, especially when the hash is implemented by hardware.

Referring in detail to applying (158) the function f(x,y), in some embodiments of the invention the function comprises a bit-wise logical function, such as ‘and’, ‘or’, ‘xor’, ‘nand’ or ‘nor’. Alternatively or additionally, the function comprises an addition or subtraction function. In some embodiments of the invention, the applied function f(x,y) is a symmetric function, which provides the same result regardless of the order in which the operands are supplied. Alternatively, a non-symmetrical function is used.

In some embodiments of the invention, the same function f(x,y) is used for all of the random numbers in the set. Alternatively, a plurality of different functions are defined, and each random number RNᵢ is associated with one of the functions, such that at least two of the random numbers are supplied to different functions.

Alternatively to adding together (160) all the digits of each of the intermediate results IRᵢ into a single bit Bᵢ, the digits of one or more of the intermediate results IRi are summed together into a plurality of bits (e.g., 2 bits). For example, one or more of the intermediate results IRᵢ is optionally divided into pairs of 2 bits. The right bits in all the pairs are optionally added into a single right bit and the left bits are optionally added together into a single left bit. The right and left bits are optionally concatenated with the added together bits of the other intermediate results IRᵢ. Optionally, the digits of the intermediate results are added together to a number including at most half the number of bits of the intermediate result, so as to reduce the effect of a single random number on the result In some embodiments of the invention, the digits of the intermediate results are added together to a number having less than 10%, or even less than 5%, of the digits that the intermediate result has. Optionally, the added together number has at most 12 bits, or even less than 6 bits.

The adding together (160) of the bits is equivalent to providing a ‘1’ bit result if the number of ‘1’ bits in the intermediate results IRᵢ is odd and a ‘0’ bit result if the number is even. Alternatively or additionally, to adding the bits together, any other function is used to mathematically combine the digits of the intermediate results IRᵢ into a limited number of bits (e.g., less than 6 or 4 bits), is used.

Alternatively to concatenating (162) the resulting bits Bᵢ into a hash result HR, the resulting bits Bᵢ are used separately in selecting the processor 102 to which the packet is to be forwarded.

In some embodiments of the invention, the random numbers generated at startup of network device 100 may be used indefinitely until the network device is restarted. Thus, the same random numbers may be used for more than a week, more than a month or even more than a year, when network device 100 is not restarted. In accordance with these embodiments, the operation of network device 100 is not interrupted in order to change the random numbers. Alternatively, if network device 100 is not restarted for over a predetermined time (e.g., two weeks), network device 100 is restarted automatically at the initiative of hash unit 104 or load balancer 106, in order to ensure that the same random numbers are not used for over a predetermined amount of time, which may allow users to determine the random numbers. Alternatively or additionally, when hash unit 104 determines operation problems of network device 100 and/or identifies that there was an attempt to determine the random numbers, a restart of network device 100 is initiated. Such a determination may be performed, for example in order to determine a sequence of packets which will be divided unevenly between the load balancers, for a malicious attack against the network device 100.

In some embodiments of the invention, a system manager may set various operation parameters of hash unit 104, such as the maximal time between restarts of network device 100 and/or the number of random numbers to be used.

Network devices 100 and 110 may be substantially any device known in the art, including, for example, a transparent bridge, server, router and/or switch.

Furthermore, the network devices may be formed of processing units which are stand alone units, such as servers (e.g., web servers, proxies, traffic monitors), in which case the network devices are optionally server farms. The processing units may all be included within a single housing or may be included in separate housings. Each of the processing units may in itself be formed of a plurality of processors. In addition to the use of the hash function for distributing packets between the processing units, a similar hash function or other method may be used to distribute the packets between the processors forming the processing unit. It will be understood that the hash method described above may be used in any level of hierarchy for distribution of packets between processors.

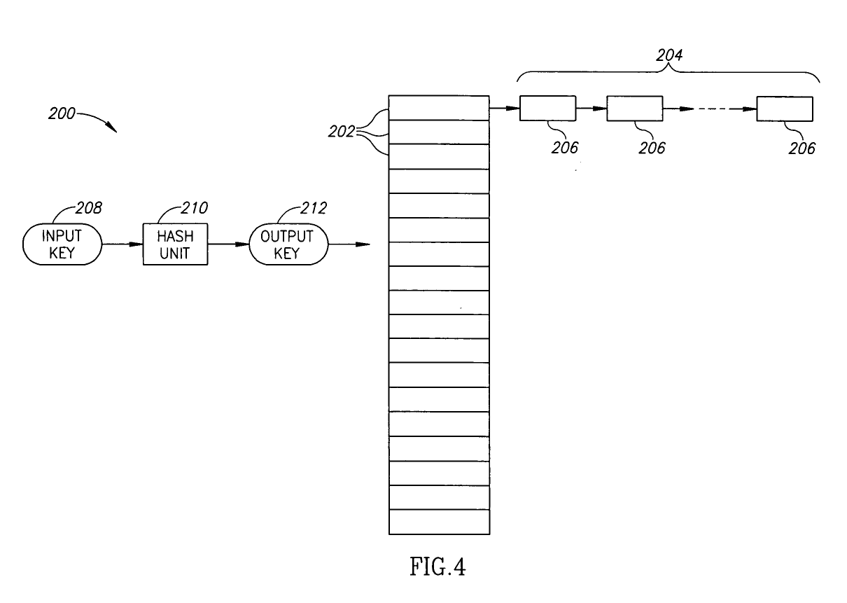

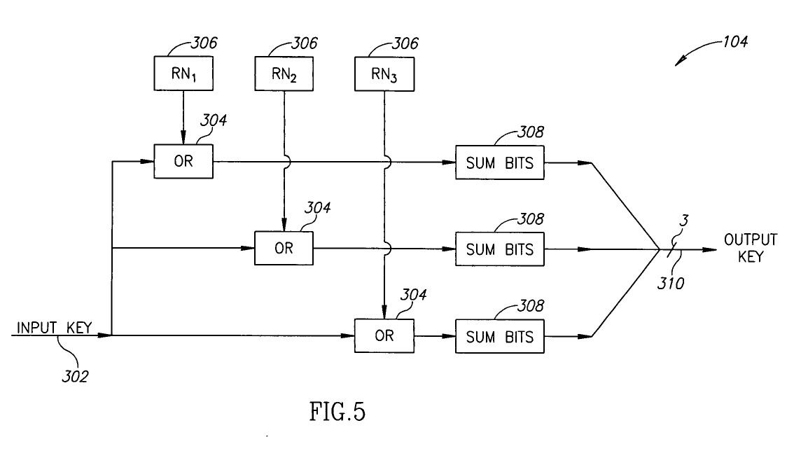

While the above description relates to selection of a processor of a network device, the same method may be used for other tasks, such as access to large tables stored in a memory unit. The large table is optionally stored in a plurality of memory modules, and the method described above is used to determine in which of the memory modules a required table entry is stored or should be stored. Alternatively or additionally, as is now described with reference to FIG. 4, the hash method described above may be used to determine the exact memory location in which the data is to be stored. The above described hash method may be used for substantially any other method which is based on a hash function, such as CRC calculations or statistical calculations which are based on a hash function.

FIG. 4 is a schematic illustration of access to data in a memory unit 200, in accordance with an exemplary embodiment of the invention. Memory unit 200 optionally comprises a plurality of entries 202 for storage of data. Each entry 202 optionally leads to a linked list 204 (shown, for clarity, only on a single entry 202), having a predetermined number of links 206.

An input key 208 is used to access an entry 202 for reading or writing. The input key 208 is provided to a hash unit 210, which generates an output key 212 of the size of the number of entries 202 in memory unit 200. In writing into an entry 202, links 206 are optionally searched for an empty location. In some embodiments of the invention, if there are no empty locations available, the writing operation fails. In reading from an entry 202, the links 206 are traversed to find the value to be read. If the value is not found in any of links 206 of the entry 202, the reading operation receives a “not found” value.

In some embodiments of the invention, hash unit 210 operates as described in the method of FIG. 3. Instead of using sub-string STR, input key 208 is used, and the concatenated hash result HR is used as output key 212. In accordance with these embodiments, the random numbers are not changed when data is stored in memory unit 200. Alternatively, the random numbers are changed periodically, and the memory is re-organized when the random numbers are changed.

Use of hash methods in accordance with some embodiments of the present invention allows for a more even distribution of the stored data in memory unit 200 and hence allows for a lower number of links 206 in linked lists 204, than was conventionally used in the prior art.

FIG. 5 is a schematic block diagram of a hash unit 104 implemented in hardware, in accordance with an exemplary embodiment of the invention. An input key received on an input line 302 is provided in parallel to “OR” units 304, each of which receives a random number (RNᵢ) from a respective latch or register 306. The results of the OR operations from “OR” units 304 are provided to respective bits summation units 308. The summed bits are concatenated together on an output line 310. In some embodiments of the invention, each bit summation unit 308 comprises an array of XOR gates used recursively to implement the adding together of the bits.

It is noted that for simplicity, FIG. 5 shows a hash unit which implements one specific embodiment of the hash function. Similar hardware implementations may be used for substantially any of the functions described above in relation to FIG. 3 and the alternatives described therewith. Particularly, instead of “OR” units 304, “AND” units or units implementing any other function may be used.

The use of a hardware unit in which separate units 304 and 308 are used for each random number, achieves a high speed of operation with a simple hardware layout. Naturally, the above described hash method may be implemented also in software, in a single hardware unit (e.g., an application specific integrated circuit (ASIC)), or in any other suitable apparatus.

In simulations performed to determine the distribution of the hash function described above, a random number of 144 bits was selected and an AND function was applied between the random number and a group of input test keys. The results of the AND function were classified as having even or odd numbers of ‘1’ bits.

In a first test group, 64 million consecutive keys were tested. 31,870,758 resulted in an even number of ‘1’ bits and 32,129,242 resulted in an odd number of ‘1’ bits. Thus, the hash function achieves a distribution which differs from a 50/50 distribution by less than 0.5%.

In a second test group, 64 million random keys were tested. The results were that 31,611,873 input values resulted in an even number of ‘1’ bits and 32,388,127 input values resulted in an odd number of ‘1’ bits.

For a third test group, 64 million consecutive input keys incremented each time by 2, were tested. The results were that 31,803,873 input values resulted in an even number of ‘1’ bits and 32,196,127 input values resulted in an odd number of ‘1’ bits.

In a fourth test group, 64 million keys incremented sequentially by 7, were tested. The results were that 32,318,768 input values resulted in an even number of ‘1’ bits and 31,681,232 input values resulted in an odd number of ‘1’ bits.

The largest deviation from an even distribution in these simulation is by a little more than 1%. Similar results were received using an OR function instead of the AND function and using a random number of 320 bits instead of 144 bits.

The present invention encompasses many implementations for providing a hash value for an input, including hardware, software and firmware. Particularly, some embodiments of the present invention include a processor, computer and/or other circuitry configured to generate hash values in accordance with the methods described above. Furthermore, some embodiments of the present invention include computer readable media, such as a disk, CD, diskette or disk-on-key, which carries software which performs the above described methods.

It will be appreciated that the above described methods may be varied in many ways, including, changing the order of steps, and/or performing a plurality of steps concurrently. It should also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

1. A method of providing a hash addressing number based on an input value, comprising:
receiving an input value;
providing one or more arbitrary numbers;
for each of the one or more arbitrary numbers, applying a multi-operand function to the input value and the arbitrary number, to generate an intermediate result;
mathematically combining the digits of the intermediate results to generate respective short bit results having less than half the bits of the intermediate results; and
using the short bit results as an output hash number or to form an output hash number for the input value.

2. A method according to claim 1, wherein receiving the input value comprises receiving at least one field of an IP packet.

3. A method according to claim 2, wherein receiving at least one field of an IP packet comprises receiving an input value including only one or more entire logical fields of an IP packet.

4. A method according to claim 1, wherein receiving the input value comprises receiving a string formed of one or more fields selected as a sub-group from a larger group of fields determined to be suitable for use in the hash, the selection of the sub-group being performed without relation to the statistical distribution of the values of the bits of the larger group.

5. A method according to claim 1, wherein providing the one or more arbitrary numbers comprises providing one or more numbers generated by a random number generator.

6. A method according to claim 5, wherein providing the one or more arbitrary numbers comprises providing numbers which are generated each time a system using the hash number is restarted.

7. A method according to claim 1, wherein the multi-operand function comprises a two-operand function.

8. A method according to claim 7, wherein the two-operand function comprises a logical bitwise function.

9. A method according to claim 1, wherein the multi-operand function is the same for all the one or more arbitrary numbers.

10. A method according to claim 1, wherein the one or more arbitrary numbers include a plurality of numbers and wherein different multi-operand functions are used for at least two of the arbitrary numbers.

11. A method according to claim 1, wherein the multi-operand function is one of ‘or’, ‘and’, ‘nor’ and ‘nand’.

12. A method according to claim 1, wherein mathematically combining the digits of the intermediate results comprises summing the digits into a single bit.

13. A method according to claim 1, wherein using the short bit results to form an output hash number for the input value comprises concatenating the short bit results to form a single number.

14. A method according to claim 1, wherein using the short bit results comprises using the short bit results or the output hash number for load balancing.

15. A method according to claim 1, wherein using the short bit results comprises using the short bit results or the output hash number for memory access.

16. A hash unit, comprising:
an input interface adapted to receive an input key;
an arbitrary number generator adapted to generate one or more arbitrary numbers;
a processor adapted to apply a multi-operand function to an input key received by the input interface together with each of one or more arbitrary numbers generated by the generator so as to generate intermediate results, to mathematically combine the digits of the intermediate results to generate respective short bit results having less than half the bits of the intermediate results and to concatenate the short bit results; and
an output unit adapted to provide the concatenated short bit results for use as an output hash key.

17. A hash unit according to claim 16, wherein the arbitrary number generator is adapted to generate new arbitrary numbers, each time the hash unit is restarted.
